(19) United States
(12) Patent Application Publication
(10) Pub. No.: US 2026/0317174 A1
(43) Pub. Date: Oct. 15, 2026

(54) CHEMICAL PROCESSING USING REGENERATIVE FROTH CONTACTOR

(71) Applicant: Industrial Climate Solutions Inc., Calgary (CA)

(72) Inventor: Yash Tamhankar, Bartlesville, OK (US)

(21) Appl. No.: 19/175,437

(22) Filed: Apr. 10, 2025

(51) Int. Cl. C01B 25/30; B01D 15/08; B01D 21/01; C01D 15/08; C22B 3/02; C22B 3/22; C22B 3/44; C22B 26/12

(52) U.S. Cl. CPC C01B 25/308; B01D 15/08; B01D 21/01; C01D 15/08; C22B 3/02; C22B 3/22; C22B 3/44; C22B 26/12

(57) ABSTRACT

A system for recovering a selected chemical includes a first supply of a liquid solution having the selected chemical, a second supply of a gas, and a vessel in flow communication with the first supply and the second supply. The vessel includes a plurality of screens disposed in a series and configured to generate froth pulses that travel inside the vessel to cause a chemical reaction between the contents to produce reaction products. The reaction products include a precipitate or reaction product liquid having the selected chemical, a remainder lean liquid and the gas. The vessel includes an output port configured to discharge the reaction products. The system also includes a separator having an input port in flow communication with the discharge port and configured to separate the precipitate or the reaction product liquid from the remainder lean liquid and the gas.

### BACKGROUND

Global warming is of concern today as the current rise in global temperatures is considered to be driven by human activities. These human activities include the burning of fossil fuels, which release greenhouse gases. These gases absorb some of the heat that the Earth radiates after the Earth is warmed from sunlight thus warming the lower atmosphere. The emission of carbon dioxide (CO₂) is considered to be the primary driver of global warming.

In an effort to curb global warming, electric vehicles or EVs, which do not emit any greenhouse gases, have become popular. EVs typically use lithium-ion batteries, which have a limited lifetime, as a power source. At the end of their life, lithium-ion batteries are generally recycled to extract their lithium.

Precipitation, solvent extraction, and sorption are established routes for recovering lithium from brines and hydrometallurgical battery recycling and for production of lithium carbonate. The production of lithium carbonate is a desired precursor for the manufacturing of lithium-ion batteries. Typical mixing and mass transfer equipment used for lithium recovery include tanks, ponds, vats or crystallizers which do not provide any or provide only limited mass transfer or mixing intensification. Conventional mass transfer devices such as structured packing which promote intensification are susceptible to plugging due to salts while homogenous reactors such as stirred tanks require extra power and large volumes of reactants. Hence, it would be appreciated in the lithium processing industry if mixing and mass transfer intensification technology was developed to make lithium processing more efficient and with a smaller footprint.

### SUMMARY

Disclosed is a system for recovering a selected chemical. The system includes a first supply of a liquid solution having the selected chemical, a second supply of a gas, and a vessel in flow communication with the first supply and the second supply. The vessel includes a plurality of screens disposed in a series and configured to generate froth pulses that travel inside the vessel to cause a chemical reaction between the contents to produce reaction products. The reaction products include a precipitate or reaction product liquid comprising the selected chemical, a remainder lean liquid and the gas. The vessel includes an output port configured to discharge the precipitate or reaction product liquid comprising the selected chemical, the remainder lean liquid, and the gas. The system also includes a separator having an input port in flow communication with the discharge port and configured to separate the precipitate or the reaction product liquid from the remainder lean liquid and the gas.

Also disclosed is a method for recovering a selected chemical. The method includes receiving a liquid solution having the selected chemical, receiving a gas, and mixing the liquid solution and the gas in a vessel having a plurality of screens disposed in a series and configured to generate froth pulses that in a direction from an input side to an output side of the vessel to mix contents in the vessel to cause a chemical reaction between the contents to produce reaction products. The reaction products include a precipitate or reaction product liquid having the selected chemical and a remainder lean fluid. The method also includes separating the precipitate or reaction product liquid comprising the selected chemical from the remainder lean fluid and the gas using a separator coupled top the vessel.

### BRIEF DESCRIPTION OF THE DRAWINGS

The following descriptions should not be considered limiting in any way. With reference to the accompanying drawings, like elements are numbered alike:

FIG. 1 depicts aspects of processing lithium using a regenerative froth contactor;

FIGS. 2A and 2B, collectively referred to as FIG. 2, depict aspects of the regenerative froth contactor;

FIG. 3 depicts aspects of lithium extraction via precipitation;

FIG. 4 depicts aspects of lithium extraction via solvent extraction;

FIG. 5 depicts aspects of lithium extraction via adsorption;

FIG. 6 depicts aspects of high purity lithium extraction via a combination of lithium-selective solvent extraction plus calcium-selective precipitation plus magnesium-specific adsorption;

FIG. 7 depicts aspects of a first embodiment of lithium extraction via precipitation from a battery recycling operation;

FIG. 8 depicts aspects of a second embodiment of lithium extraction via precipitation from a battery recycling operation;

FIG. 9 depicts aspects of an embodiment of lithium carbonate production via carbonation as an end step for lithium recovery from unconventional brine;

FIG. 10 depicts aspects of another embodiment for lithium carbonate production via carbonation for lithium recovery from lithium-containing ore or brine. ; and

FIG. 11 is a flow chart for a method for recovering a selected chemical.

### DETAILED DESCRIPTION

A detailed description of one or more embodiments of the disclosed apparatus and method are presented herein by way of exemplification and not limitation with reference to the Figures.

In the figures, lines or arrows represent conduits such as pipes or ducts for flowing a selected material depicted in the associated figure. A port or connection of a component is represented by a location of where a line or arrow intersects with the component. For example, an intersection of a line or arrow with a body of a component as shown in a figure is representative of a port of the body, a connection to the body, or a connector connecting to the body and may be collectively referred to as an input or output. Material motivators such as pumps and compressors are not shown but may be present as needed based on a configuration of the conduits and components. Conduit fittings such as unions or tees and the like are not shown. Similarly, conduit hangers and supports are also not shown.

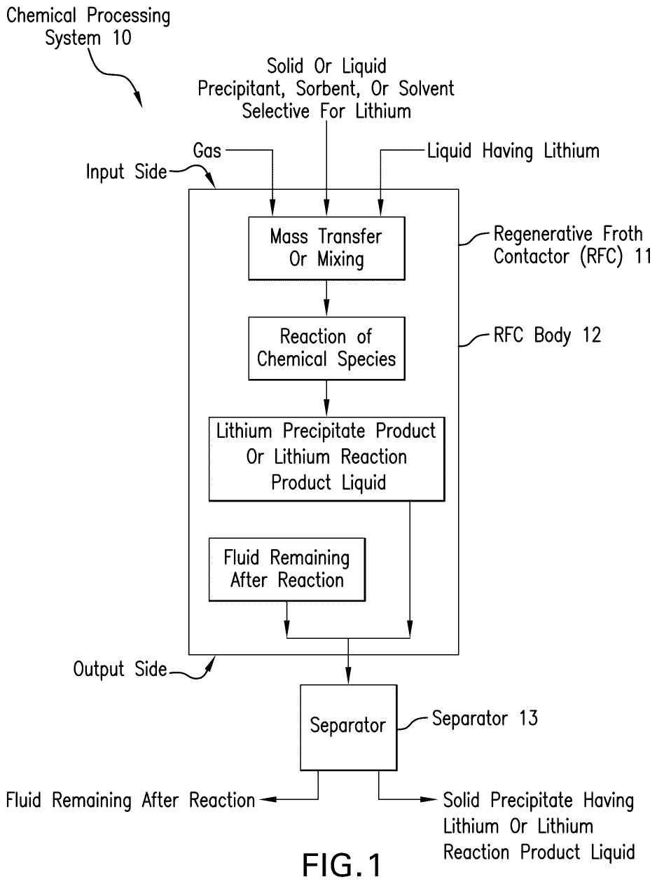

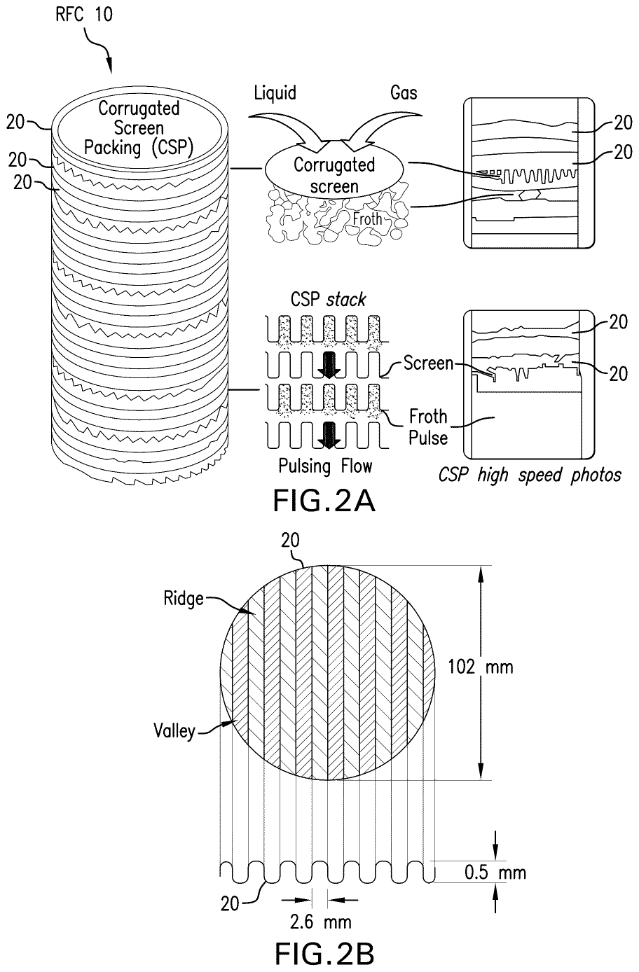

FIG. 1 depicts aspects of a chemical processing system 10 at a general level. The chemical processing system 10 is configured to recover a selected chemical from a solution having the chemical. For teaching purposes, the selected chemical is lithium. However, the apparatus and process can be applied to recover other chemicals. The chemical processing system 10 includes a vessel, preferably a regenerative froth contactor (RFC) 11, that mixes (i) a liquid solution having lithium, (ii) a liquid or solid of a precipitant, sorbent, or solvent selective for lithium and (iii) a gas. The RFC 11 is discussed in detail further below with respect to FIG. 2. Flowing of the liquid solution, the material selective for lithium, and the gas through the RFC 11 causes mass transfer and/or intense mixing of the liquid solution, the material selective for lithium, and the gas within the RFC 11 by increasing the mass transfer interfacial area. As a result of the mass transfer and/or intense mixing, a chemical reaction occurs between the various chemical species in the liquid solution, the material selective for lithium, and the gas. The reaction results in a reaction product containing lithium that precipitates out or forms a lithium-rich liquid. The term “lithium-rich” relates to the liquid having a concentration of lithium that is greater than the concentration of lithium in the liquid solution entering the RFC 11. The reaction product may precipitate out or form the lithium-rich liquid without any requirement for cooling or may rapidly precipitate out or form the lithium-rich liquid on account of heat removal. In certain embodiments, a solid may also be input into the RFC 11 where the mixing of the solid, gas, and liquid solution causes a reaction of the various chemical species resulting in a lithium-containing reaction product. The species flowing through the RFC 11 flow co-currently. That is, they flow within a body 12 in the same direction such as from top (or an input side) to bottom (or an output side) in a non-limiting embodiment. It can be appreciated that multiple RFCs 11 may be used in a series configuration, a parallel configuration, or a series-parallel combination configuration. In general, the precipitation product is entrained within a remainder fluid and a separator 13 is used to separate the lithium-containing reaction product from the remainder fluid. The separator 13 can implement any configuration, method, or technology known in the art for separating the lithium-containing reaction product from the fluid.

FIG. 2 depicts aspects of the regenerative froth contactor (RFC) 11. FIG. 2A is an inside view of an embodiment of the RFC 11. The RFC 11 includes a plurality of mesh screen layers 20 stacked in series with a space between each of the layers 20. In one or more embodiments, one or more of the mesh screen layers 20 are a corrugated screen packing layer (referred to a CSP 20) to enhance the generation of froth. As a liquid and gas (i.e., species) flow in the same direction through the layers 20, froth pulses are generated and travel in the direction of the liquid and gas flow. In one or more embodiments, the mesh screen in the layers is corrugated to enhance the generation of the froth pulses. The generation of the froth pulses cause intense mixing and/or mass transfer of the species flowing through the RFC 11 in an efficient and compact configuration. The intense mixing and/or mass transfer causes a chemical reaction among the flowing species and results in precipitation of the selected chemical from the liquid solution having the chemical. The generation of froth pulses is illustrated in the center and right side of FIG. 2A. An upper portion of FIG. 2B illustrates a top view of one mesh screen layer 20 while a lower portion of FIG. 2B illustrates a side view of the mesh screen layer 20 noting the corrugation. Dimensions are shown for one embodiment of the mesh screen layer 20 but can vary depending on a selected size and/or particular needs of the RFC 11. In general, the mesh screen layers 20 are disposed in the body 12 having an input side and an output side (see FIG. 1) such that the body 12 encases or directs the flow of the liquid and gas through the RFC 11. The froth pulses migrate or travel from the input side to the output side at a speed V_{fp} that is less than the speed of the fluids V_{fl} traveling through the RFC 11 (V_{fp}<V_{fl}) so that the fluids will interact with multiple froth pulses to intensify the mixing. The RFC 11 may be described in more general terms as a vessel defining a volume which contains a plurality of mesh screens disposed in a series arrangement.

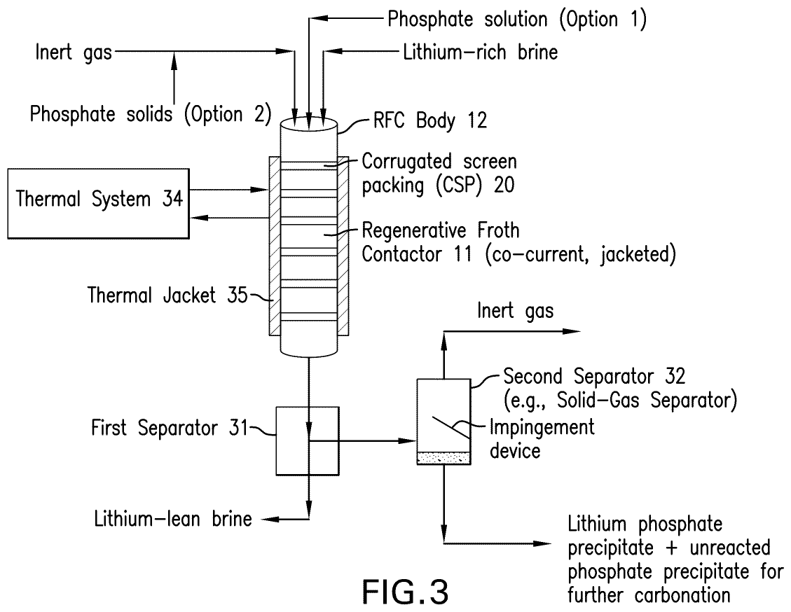

The embodiments presented in FIGS. 3-6 may be used for lithium recovery from lithium-rich (Li-rich) brine pumped from underground deposits for example.

FIG. 3 depicts aspects of lithium extraction via precipitation. In the embodiment of FIG. 3 (Option 1), an inert gas, a phosphate solution, and a lithium-rich (Li-rich) brine are input into the RFC 11 where intense mixing occurs. The phosphate solution (liquid) is contacted with the Li-rich brine in the RFC 11. Here, the inert gas such as nitrogen is used to create the froth to promote formation of pulses and intensely mix the three phases: phosphate solution (liquid), Li-rich brine (liquid), and the inert gas. This option uses a phosphate solution and the chemical reaction in the RFC 11 results in lithium-lean brine (having less lithium than the lithium-rich brine) and a lithium phosphate precipitate where both reaction products are entrained in the inert gas. Downstream of the RFC 11, two phases of separation are carried out. First, the lithium-lean brine is separated from the combination of the lithium phosphate precipitate entrained in the inert gas by a first separator 31. The first separator 31 can be based on gravity (if the phases are immiscible and the density differs) or distillation in non-limiting embodiments. Second, the inert gas is separated from the lithium phosphate precipitate by a second separator 32 such as a hydrocyclone or other type of a solid-gas separator. The solid-gas separator may include an impingement device as illustrated for operation. Any unreacted lithium phosphate precipitate may be further processed for further carbonation. The sequence of the two separators employed and the phases separated sequentially may change based on the choice and type of separator used.

In the embodiment of FIG. 3, the internal temperature of the RFC 11 and thus the temperature of the contents therein is controlled or maintained by a thermal system 34. The thermal system 34 includes a thermal jacket 35 at least partially surrounding the body 11 of the RFC 11. The thermal system 34 is configured to heat or cool the contents of the RFC 11 depending on the temperature needed for a particular chemical reaction or speed of a particular chemical reaction desired in the RFC 11 or to induce precipitation if required. In one or more embodiments, the thermal jacket 35 is configured to receive a heated fluid for heating applications or a refrigerant or cooling liquid for cooling applications. Other heating or cooling technologies may also be used.

In the embodiment of FIG. 3 (Option 2), the phosphate solids are entrained by the inert gas and carried into the RFC where they contact the Li-rich brine. Subsequent intense mixing and reaction result in a Li-phosphate precipitate that is separated out. This option uses phosphate solids and the chemical reaction for this option is 3Lᵢ^{+ (aq)+Na}₃PO₄ (s)+Li₃PO₄ (s)+3Na⁺ (aq) and results in lithium-lean brine (having less lithium than the lithium-rich brine) and a lithium phosphate precipitate where both reaction products are entrained in the inert gas. To facilitate rapid precipitation of the Li-phosphate, the RFC 11 is provided with the thermal jacket 35 for cooling with chilled water or refrigerant circulating through the jacket. Separation of components discharged from the RFC 11 is similar to the separation techniques discussed with respect to Option 1. It can be appreciated that Options 1 and 2 can be combined to improve the lithium recovery process.

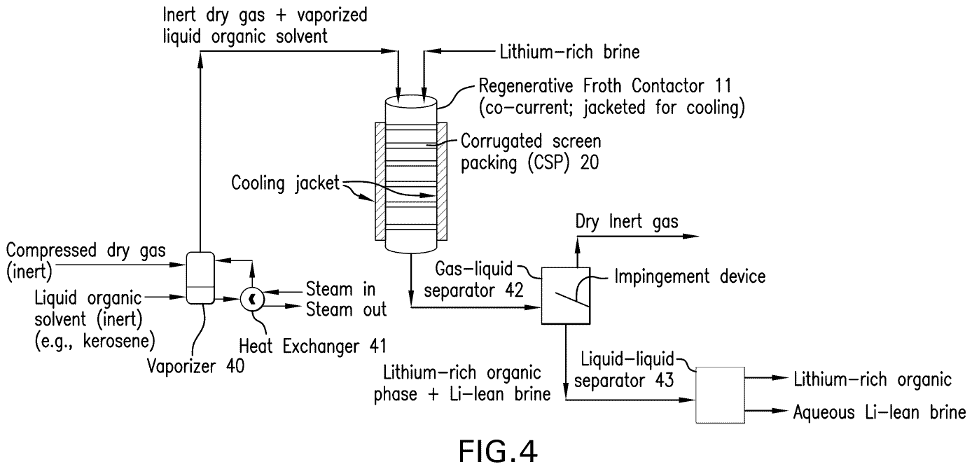

FIG. 4 depicts aspects of lithium extraction via solvent extraction. In the embodiment of FIG. 4, a liquid organic solvent such as kerosene is first vaporized in a vaporizer 40 and mixed with compressed inert gas and carried into the RFC 11. Here the organic solvent vapor contacts the Li-rich brine and pulls the Li out of the aqueous brine due to its higher solubility in the organic phase. Fluid in the vaporizer 40 is heated by being circulated through one side of a heat exchanger 41. Another side of the heat exchanger 41 can be heated by steam or other hot fluid. In case the organic solvent does not condense due to contacting the ambient temperature Li-rich brine, a cooling jacket may be utilized to cool the fluids inside the RFC 11. The RFC 11 discharges aqueous Li-lean brine, Li-rich organic phase, dry inert gas. These components are fed to a first separator 42, which is a gas-liquid separator, to separate the dry inert gas from the aqueous Li-lean brine and Li-rich organic phase. The aqueous Li-lean brine and Li-rich organic phase are then fed to a second separator 43, which is a liquid-liquid separator, to separate the Li-rich organic phase from the aqueous Li-lean brine.

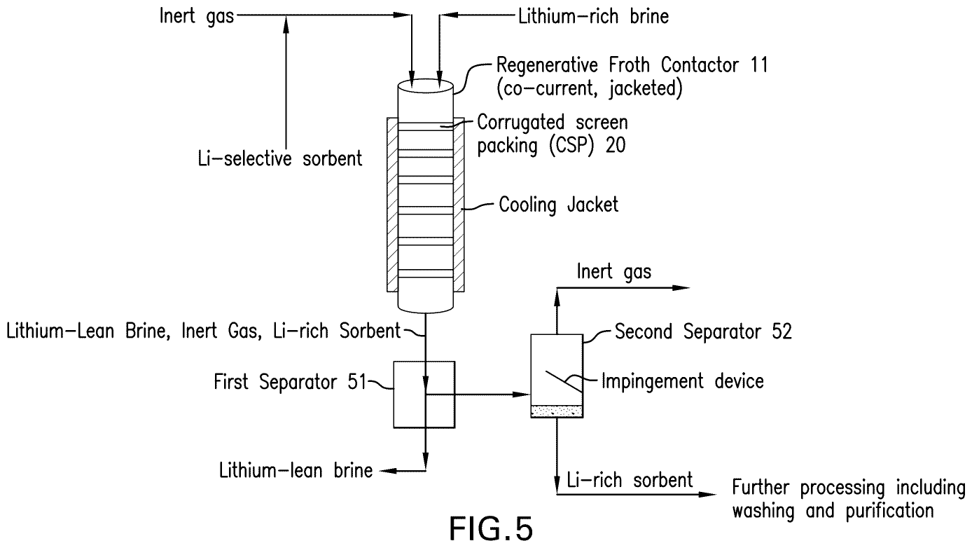

FIG. 5 depicts aspects of lithium extraction via adsorption. In the embodiment of FIG. 5, an inert gas is combined with a lithium-selective sorbent such as Na₃PO₄ in a non-limiting example. Other lithium-selective sorbents may also be used. The combination of the inert gas and sorbent is then intensely mixed with a lithium-rich brine in the RFC 11. Due to the intense mixing in the RFC 11, a chemical reaction occurs that results in a Li-rich sorbent liquid and a lithium-lean brine as reaction products. The lithium-lean brine has a lower concentration of lithium than the lithium-rich brine. A cooling jacket may be used to increase the capacity of the Li-rich sorbent. In one or more embodiments, cooling is in a range of 15-20 degrees C for purely cooling to either manage the exothermic reaction or increase the sorption capacity of the sorbent. A lower cooling range may be used when the phases need to be cooled to induce precipitation. The inert gas, the Li-rich sorbent liquid, and the lithium-lean brine are discharged from the RFC 11 and provided to a first separator 51 that is configured to separate the lithium-lean brine solution from a combination of the inert gas and the Li-rich sorbent liquid. The inert gas and the Li-rich sorbent liquid are provided to a second separator 52, which is a gas-liquid separator configured to separate the inert gas from the Li-rich sorbent liquid. In a non-limiting embodiment, the second separator 52 includes selective membrane technology that uses external driving forces such as pressure for nanofiltration, an electric field for selective electrodialysis, or a thermal gradient to provide separation. The Li-rich sorbent liquid may be further processed to include washing and purification.

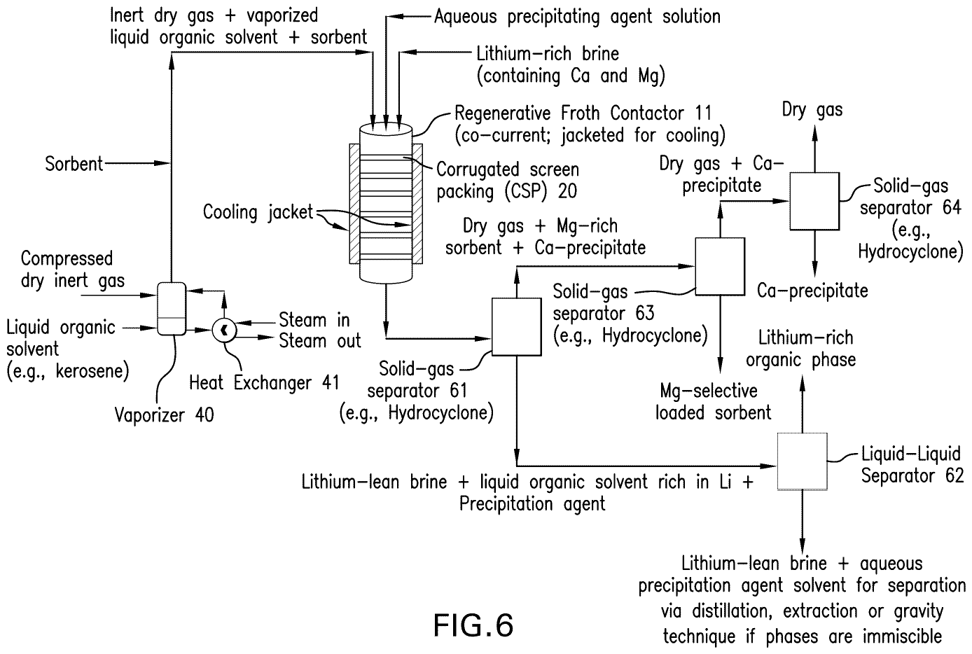

FIG. 6 depicts aspects of lithium extraction via a combination of solvent extraction plus precipitation plus adsorption. Salt-rich water or brines from underground deposits may have other species in addition to lithium such as Ca and Mg for example. The techniques disclosed in the embodiment of FIG. 6 may be used to remove the other species thus improving the purity of the Li recovered. In the embodiment of FIG. 6, aspects of extraction or separation of three common species found in brines are presented: Li, Ca and Mg. Ca and Mg, compete with Li for either organic solvent affinity, or sorbent adherence. By removing the Ca and Mg, the selectivity of the Li recovery or purity can be improved. Alginate-Citrate sorbents can remove Ca and Mg ions from the Li-rich brine. Zeolites can be used for removing Mg. Different species can be targeted for separation. For example, an organic solvent can be Li-selective, a sorbent can be Mg-selective, and precipitation by reaction can be Ca-selective. Calcium can be precipitated out using sodium carbonate (Na₂CO₃). Combining selective removal of Ca and Mg with Li-recovery can improve yield (mass Li/mass of either organic solvent or sorbent) and purity of recovered Li.

In the embodiment of FIG. 6, a compressed inert gas and a liquid organic solvent such as kerosene for example are introduced to a vaporizer 40. The vaporizer 40 is configured to heat the liquid organic solvent into a vapor. Heat to vaporize the solvent is provided by a first side of a heat exchanger 41. A second side of the heat exchanger 41 receives heat from a heat source such as in the form of steam for example. The solvent vapor and the compressed inert gas are discharged from the vaporizer 40 and combined with a sorbent. A combination of the compressed inert gas, the solvent vapor, and the sorbent are fed into the RFC 11. The RFC 11 also receives an aqueous precipitating agent solution and a lithium-rich brine containing Ca and Mg. The froth pulses migrating the in the RFC 11 cause intense mixing resulting in a chemical reaction among the various species. The resulting components discharged by the RFC 11 include the inert gas, an Mg-rich sorbent, a Ca-precipitate, a lithium-lean brine, a liquid organic solvent rich in Li, and an aqueous precipitation agent. These components are fed into a first separator 61, which is a solid-gas separator such as a hydrocyclone. The first separator 61 is configured to separate the lithium-lean brine plus the liquid organic solvent rich in Li plus the precipitation agent from the inert gas plus the Mg-rich sorbent plus the Ca-precipitate. The lithium-lean brine plus the liquid organic solvent rich in Li plus the aqueous precipitation agent is fed into a second separator 62, which is a liquid-liquid separator and may be based on gravity technology for separating one type of liquid from another type of liquid. The second separator 62 is configured to separate the lithium-rich organic phase from the lithium-lean brine plus the aqueous precipitation agent. The lithium-rich organic phase may undergo further separation processing according to needs for the recovered lithium. The lithium-lean brine plus aqueous precipitation agent may also undergo further separation processing as needed such as via distillation, extraction or gravity technique if phases are immiscible. The inert gas plus the Mg-rich sorbent plus the Ca-precipitate are fed to a third separator 63, which is also a solid-gas separator such as a hydrocyclone. The third separator 63 is configured to separate the Mg-rich sorbent from the inert gas and the Ca-precipitate. The inert gas and the Ca-precipitate are fed to a fourth separator 64, which is also a solid-gas separator such as a hydrocyclone. The fourth separator 64 is configured to separate the Ca-precipitate from the inert gas. The sequence of the separators employed and the phases separated sequentially can change based on the choice and type of separator used.

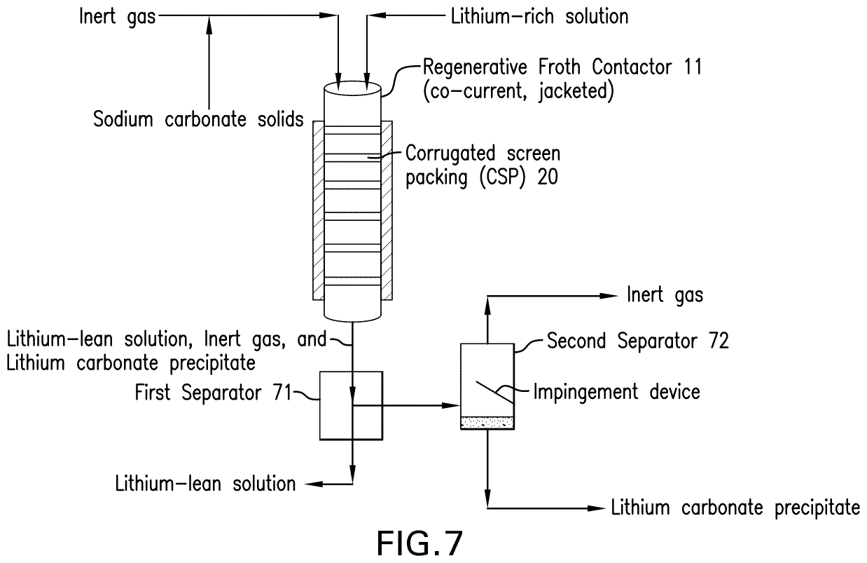

FIG. 7 depicts aspects of an embodiment for lithium extraction via precipitation for a lithium battery recycling operation in which Li-carbonate is obtained. Li-carbonate is a preferred Li reagent for battery manufacturing. In the embodiment of FIG. 7, an inert gas, sodium carbonate solids, and a lithium-rich solution or leachate obtained from a lithium battery recycling operation are input into the RFC 11. The intense mixing in the RFC 11 causes a reaction in which lithium from the solution combines with the sodium carbonate to form a lithium carbonate precipitate. The remaining fluid is the inert gas with lithium carbonate precipitate and a lithium-lean solution that has less lithium than the lithium-rich solution. Accordingly, the inert gas, the lithium carbonate precipitate, and the lithium-lean solution are discharged from the RFC 11 and provided to a first separator 71 that is configured to separate the lithium lean solution from a combination of the inert gas and the lithium carbonate precipitate. The combination of the inert gas and the lithium carbonate precipitate is then provided to a second separator 72, which is a solid-gas separator that is configured to separate the lithium carbonate precipitate from the inert gas. The separators 71 and 72 may implement any separation technology known in the art.

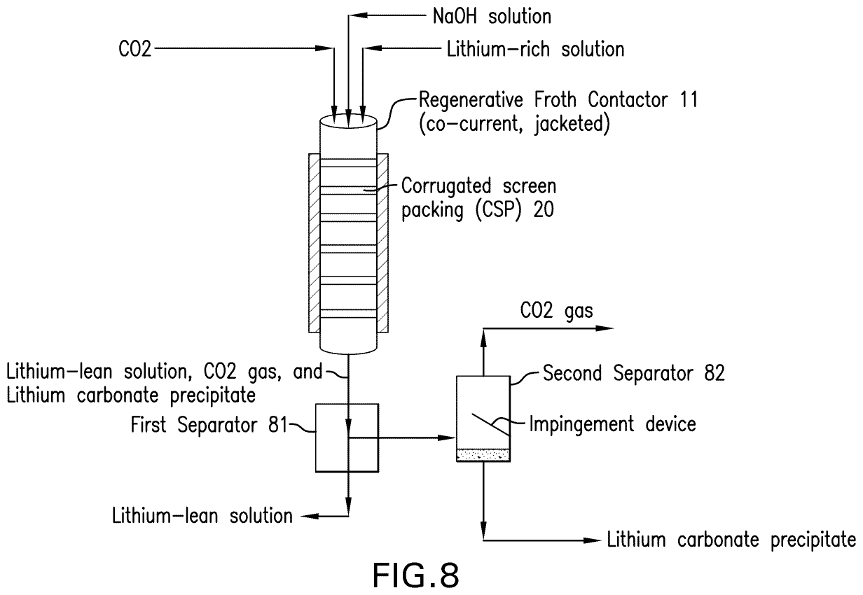

FIG. 8 depicts aspects of another embodiment for lithium extraction via precipitation for a lithium battery recycling operation in which Li-carbonate is obtained. In the embodiment of FIG. 8, carbon dioxide (CO₂) gas, a sodium hydroxide (NaOH) solution, and a lithium-rich solution or leachate obtained from a lithium battery recycling operation are input into the RFC 11. The intense mixing in the RFC 11 causes a reaction in between the CO₂ and NaOH to produce sodium carbonate (primarily) and bicarbonate (secondarily because the reaction rate of carbonate formation is much greater than bicarbonate formation) in-situ. The reaction of the sodium carbonate then reacts with the Li ions in the brine to produce lithium carbonate precipitate. The remaining fluid is the CO₂ gas with lithium carbonate precipitate and a lithium-lean solution that has less lithium than the lithium-rich solution. Accordingly, the CO₂ gas, the lithium carbonate precipitate, and the lithium-lean solution are discharged from the RFC 11 and provided to a first separator 81 that is configured to separate the lithium-lean solution from a combination of the CO₂ gas and the lithium carbonate precipitate. The combination of the CO₂ gas and the lithium carbonate precipitate is then provided to a second separator 82, which is a solid-gas separator that is configured to separate the lithium carbonate precipitate from the CO₂ gas. The separators 81 and 82 may implement any separation technology known in the art. Alternatively (not depicted in FIG. 8), solid NaOH particles can be entrained and introduced into the RFC instead of using an aqueous NaOH solution.

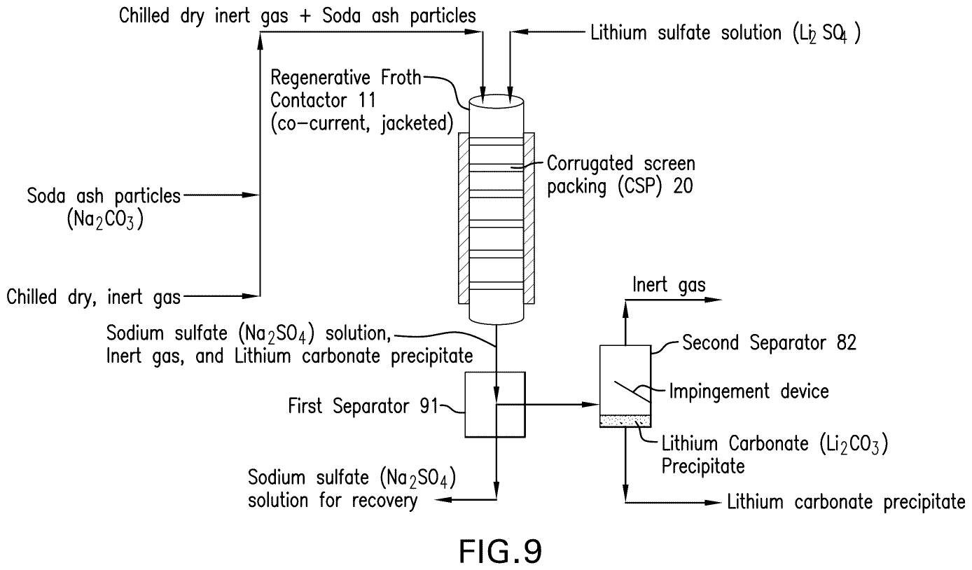

FIG. 9 depicts aspects of an embodiment for lithium carbonate production via carbonation where the Li-rich solution originates from lithium-containing ore or brine. In the embodiment of FIG. 9, an inert gas, which may be chilled and dry, soda ash particles (Na₂CO₃), and a lithium sulfate (Li₂SO₄) solution (or lithium chloride solution) obtained from the ore or brine are input into the RFC 11. The intense mixing in the RFC 11 causes a chemical reaction resulting in a lithium carbonate precipitate and a sodium sulfate (Na₂SO₄) solution. Accordingly, the inert gas, the lithium carbonate precipitate, and the sodium sulfate solution are discharged from the RFC 11 and provided to a first separator 91 that is configured to separate the sodium sulfate solution from a combination of the inert gas and the lithium carbonate precipitate. The combination of the inert gas and the lithium carbonate precipitate is then provided to a second separator 92, which is a solid-gas separator that is configured to separate the lithium carbonate precipitate from the inert gas. The separators 91 and 92 may implement any separation technology known in the art. The sodium sulfate solution can be recovered for further use.

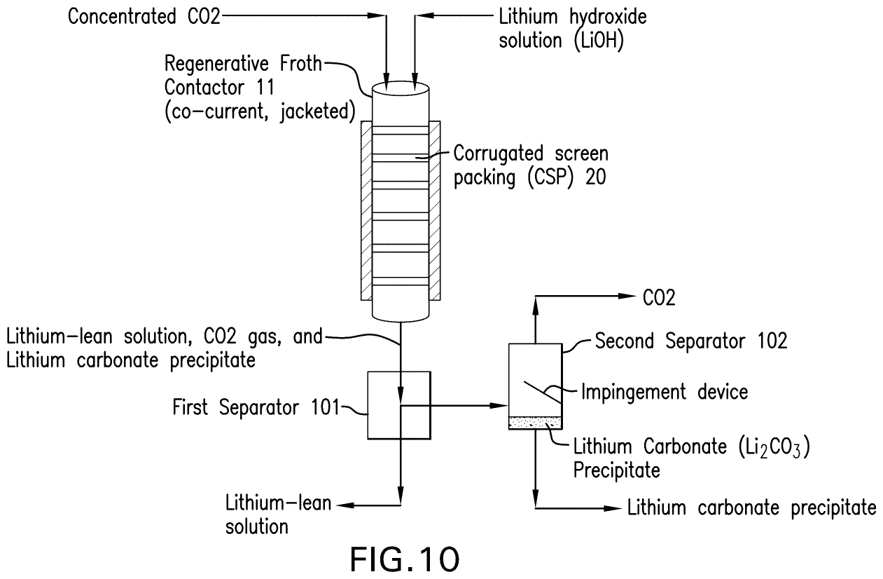

FIG. 10 depicts aspects of another embodiment for lithium carbonate production via carbonation from a lithium hydroxide (LiOH) solution originating from lithium-containing ore or brine. In the embodiment of FIG. 10, a concentrated CO₂ gas and a LiOH solution are input into the RFC 11. The LiOH solution is obtained from processing of the ore or brine as is known in the art. Due to the intense mixing in the RFC 11, a chemical reaction occurs in the RFC 11 to form a lithium carbonate precipitate and a lithium-lean solution. Accordingly, the CO₂ gas, the lithium carbonate precipitate, and the lithium-lean solution are discharged from the RFC 11 and provided to a first separator 101 that is configured to separate the lithium-lean solution from a combination of the CO₂ gas and the lithium carbonate precipitate. The combination of the CO₂ gas and the lithium carbonate precipitate is then provided to a second separator 102, which is a solid-gas separator that is configured to separate the lithium carbonate precipitate from the CO₂ gas. The separators 101 and 102 may implement any separation technology known in the art. In more general terms, the CO₂ represents a reactive gas that reacts with contents in the RFC 11 to form a precipitant inside the RFC 11.

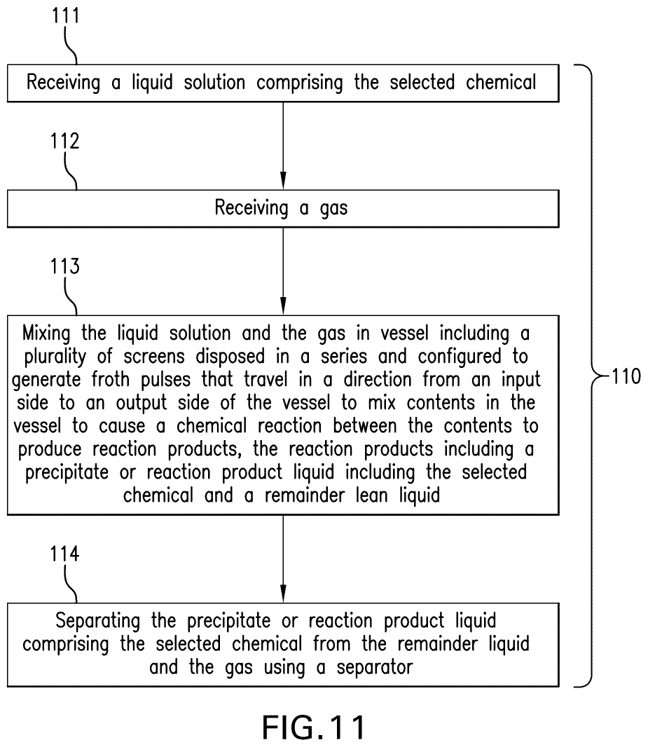

FIG. 11 is a flow chart for a method 110 for recovering a selected chemical. In one or more embodiments, the selected chemical is lithium although the technology disclosed herein can be applied to recover other chemicals including other precious metals such as germanium or gallium. Block 111 calls for receiving a liquid solution comprising the selected chemical. Block 112 calls for receiving a gas. Block 112 may also include receiving at least one of a precipitant, a sorbent, or a solvent selective for the selected chemical. In one or more embodiments, the gas is an inert gas such as nitrogen or a dry inert gas. In one or more embodiments, the gas is a reactive gas such as CO₂ for carbonation when in a nonlimiting example only the gas and liquid solution are mixed and reacted in the vessel, wherein the vessel is the RFC 11.

Block 113 calls for mixing the liquid solution and the gas in a vessel including a plurality of screens disposed in a series and configured to generate froth pulses that travel in a direction from an input side to an output side of the vessel to mix contents in the vessel to cause a chemical reaction between the contents to produce reaction products, the reaction products including a precipitate or reaction product liquid including the selected chemical and a remainder lean liquid remaining after the chemical reaction. Block 113 may also include mixing the liquid solution, the gas, and the at least one of the precipitant, the sorbent, or the solvent when the at least one of the precipitant, the sorbent, or the solvent is received. The vessel may represent a plurality of vessels and the method may further include flowing the liquid solution and the gas through the plurality of vessels disposed in a configuration including at least one of in parallel, in series, or a combination of in parallel and series. The combination for example may include two legs in parallel with each leg having a series of vessels. In one or more embodiments, the vessel having the plurality of screens is a regenerative froth contactor (RFC).

Block 114 calls for separating the precipitate or reaction product liquid comprising the selected chemical from the remainder liquid and the gas using a separator.

The method 110 may also include maintaining a temperature of contents within the vessel using a thermal system in thermal communication with the vessel. The thermal system may include thermal jacket surrounding the vessel.

The method 110 may also include: vaporizing the solvent using a vaporizer to produce a solvent vapor; combining the solvent vapor with the gas in the vaporizer to provide a combination of the solvent vapor and the gas; and flowing the combination of the solvent vapor and the gas to the RFC.

The method 110 may also include removing a first chemical other than the selected chemical from the liquid solution using a precipitant selective for the first chemical flowing through the RFC. The method 110 may further include removing a second chemical other than the selected chemical and the first chemical from the liquid solution using a sorbent selective for the second chemical flowing the RFC, wherein the selected chemical is removed using the solvent.

The technology disclosed herein provides several advantages. One advantage is that the footprint of the technology is substantially less than conventional technology for chemical recovery. Another advantage is that the use of the RFC provides for a chemical recovery operation that is more efficient than a conventional technology-based chemical recovery operation.

Set forth below are some embodiments of the foregoing disclosure:
Embodiment 1: A system for recovering a selected chemical, the system comprising a first supply of a liquid solution comprising the selected chemical, a second supply of a gas, a vessel in flow communication with the first supply and the second supply, the vessel comprising a plurality of screens disposed in a series and configured to generate froth pulses that travel inside the vessel to cause a chemical reaction between the contents to produce reaction products, the reaction products comprising a precipitate or reaction product liquid comprising the selected chemical, a remainder lean liquid and the gas, the vessel comprising an output port configured to discharge the precipitate or reaction product liquid comprising the selected chemical, the remainder lean liquid, and the gas, and a separator comprising an input port in flow communication with the discharge port and configured to separate the precipitate or the reaction product liquid from the remainder lean liquid and the gas.
Embodiment 2: The system according to any prior embodiment, wherein the selected chemical is lithium.
Embodiment 3: The system according to any prior embodiment, wherein the gas is at least one of a reactive gas and an inert gas.
Embodiment 4: The system according to any prior embodiment, further comprising a third supply of at least one of a precipitant, a sorbent, or a solvent selective for the selected chemical, wherein the vessel is in further flow communication with the third supply.
Embodiment 5: The system according to any prior embodiment, further comprising a vaporizer in flow communication with the second supply and the third supply and configured to vaporize the solvent and to output a mixture of vaporized solvent and the gas, the vaporizer comprising an output port coupled to an input of the vessel.
Embodiment 6: The system according to any prior embodiment, wherein the vessel comprises a plurality of vessels in a configuration comprising at least one of the vessels in parallel, the vessels in series, or the vessels in parallel and series.
Embodiment 7: The system according to any prior embodiment, further comprising a thermal system in thermal communication with the vessel and configured to control a temperature of the contents in the vessel.
Embodiment 8: The system according to any prior embodiment, further comprising a heat exchanger configured to supply energy to vaporize the solvent.
Embodiment 9: The system according to any prior embodiment, wherein the separator comprises at least one of a solid-gas separator configured to separate a solid from a gas or a liquid-liquid separator configured to separate a first liquid from a second liquid.
Embodiment 10: The system according to any prior embodiment, wherein the separator comprises a plurality of separators disposed in at least one of a series or parallel configuration.
Embodiment 11: The system according to any prior embodiment, further comprising a supply of a precipitant selective for a first chemical other than the selected chemical in flow communication with the vessel.
Embodiment 12: The system according to any prior embodiment, further comprising a supply of a sorbent selective for a second chemical other than the selected chemical in flow communication with the vessel, wherein the second supply comprises the solvent selective for the selected chemical and not the precipitate and the sorbent.
Embodiment 13: A method for recovering a selected chemical, the method comprising receiving a liquid solution comprising the selected chemical, receiving a gas, mixing the liquid solution and the gas in a vessel comprising a plurality of screens disposed in a series and configured to generate froth pulses that in a direction from an input side to an output side of the vessel to mix contents in the vessel to cause a chemical reaction between the contents to produce reaction products, the reaction products comprising a precipitate or reaction product liquid comprising the selected chemical and a remainder lean fluid, and separating the precipitate or reaction product liquid comprising the selected chemical from the remainder lean fluid and the gas using a separator coupled top the vessel.
Embodiment 14: The method according to any prior embodiment, wherein the gas is a reactive gas.
Embodiment 15: The method according to any prior embodiment, further comprising receiving in the vessel at least one of a precipitant, a sorbent, or a solvent selective for the selected chemical.
Embodiment 16: The method according to any prior embodiment, wherein the gas is an inert gas.
Embodiment 17: The method according to any prior embodiment, further comprising vaporizing the solvent using a vaporizer to produce a solvent vapor, combining the solvent vapor with the gas in the vaporizer to provide a combination of the solvent vapor and the gas, and flowing the combination of the solvent vapor and the gas to the vessel.
Embodiment 18: The method according to any prior embodiment, further comprising removing a first chemical other than the selected chemical from the liquid solution using a precipitant selective for the first chemical flowing through the vessel.
Embodiment 19: The method according to any prior embodiment, further comprising removing a second chemical other than the selected chemical and the first chemical from the liquid solution using a sorbent selective for the second chemical flowing the vessel, wherein the selected chemical is removed using the solvent.

The use of the terms “a” and “an” and “the” and similar referents in the context of describing the invention (especially in the context of the following claims) are to be construed to cover both the singular and the plural, unless otherwise indicated herein or clearly contradicted by context. The terms “including” and “having” and the like are intended to be inclusive such that there may be additional elements other than the elements listed. The conjunction “or” when used with a list of at least two terms is intended to mean any term or combination of terms. The term “configured” relates one or more structural limitations of a device that are required for the device to perform the function or operation for which the device is configured. The term “coupled” relates to being directly coupled or indirectly coupled using an intermediate component. The terms “first,” “second,” and the like herein do not denote any order, quantity, or importance, but rather are used to distinguish one element from another.

The flow diagram depicted herein is just an example. There may be many variations to this diagram or the steps (or operations) described therein without departing from the scope of the invention. For example, operations may be performed in another order or other operations may be performed at certain points without changing the specific disclosed sequence of operations with respect to each other. All of these variations are considered a part of the claimed invention.

The disclosure illustratively disclosed herein may be practiced in the absence of any element which is not specifically disclosed herein.

While one or more embodiments have been shown and described, modifications and substitutions may be made thereto without departing from the scope of the invention. Accordingly, it is to be understood that the present invention has been described by way of illustrations and not limitation.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A system for recovering a selected chemical, the system comprising:
a first supply of a liquid solution comprising the selected chemical;
a second supply of a gas;
a vessel in flow communication with the first supply and the second supply, the vessel comprising a plurality of screens disposed in a series and configured to generate froth pulses that travel inside the vessel to cause a chemical reaction between the contents to produce reaction products, the reaction products comprising a precipitate or reaction product liquid comprising the selected chemical, a remainder lean liquid and the gas, the vessel comprising an output port configured to discharge the precipitate or reaction product liquid comprising the selected chemical, the remainder lean liquid, and the gas; and
a separator comprising an input port in flow communication with the discharge port and configured to separate the precipitate or the reaction product liquid from the remainder lean liquid and the gas.

2. The system according to claim 1, wherein the selected chemical is lithium.

3. The system according to claim 1, wherein the gas is at least one of a reactive gas and an inert gas.

4. The system according to claim 1, further comprising a third supply of at least one of a precipitant, a sorbent, or a solvent selective for the selected chemical, wherein the vessel is in further flow communication with the third supply.

5. The system according to claim 4, further comprising a vaporizer in flow communication with the second supply and the third supply and configured to vaporize the solvent and to output a mixture of vaporized solvent and the gas, the vaporizer comprising an output port coupled to an input of the vessel.

6. The system according to claim 1, wherein the vessel comprises a plurality of vessels in a configuration comprising at least one of the vessels in parallel, the vessels in series, or the vessels in parallel and series.

7. The system according to claim 1, further comprising a thermal system in thermal communication with the vessel and configured to control a temperature of the contents in the vessel.

8. The system according to claim 7, further comprising a heat exchanger configured to supply energy to vaporize the solvent.

9. The system according to claim 1, wherein the separator comprises at least one of a solid-gas separator configured to separate a solid from a gas or a liquid-liquid separator configured to separate a first liquid from a second liquid.

10. The system according to claim 9, wherein the separator comprises a plurality of separators disposed in at least one of a series or parallel configuration.

11. The system according to claim 1, further comprising a supply of a precipitant selective for a first chemical other than the selected chemical in flow communication with the vessel.

12. The system according to claim 11, further comprising a supply of a sorbent selective for a second chemical other than the selected chemical in flow communication with the vessel, wherein the second supply comprises the solvent selective for the selected chemical and not the precipitate and the sorbent.

13. A method for recovering a selected chemical, the method comprising:
receiving a liquid solution comprising the selected chemical;
receiving a gas;
mixing the liquid solution and the gas in a vessel comprising a plurality of screens disposed in a series and configured to generate froth pulses that in a direction from an input side to an output side of the vessel to mix contents in the vessel to cause a chemical reaction between the contents to produce reaction products, the reaction products comprising a precipitate or reaction product liquid comprising the selected chemical and a remainder lean fluid; and
separating the precipitate or reaction product liquid comprising the selected chemical from the remainder lean fluid and the gas using a separator coupled top the vessel.

14. The method according to claim 13, wherein the gas is a reactive gas.

15. The method according to claim 13, further comprising receiving in the vessel at least one of a precipitant, a sorbent, or a solvent selective for the selected chemical.

16. The method according to claim 13, wherein the gas is an inert gas.

17. The method according to claim 15, further comprising:
vaporizing the solvent using a vaporizer to produce a solvent vapor;
combining the solvent vapor with the gas in the vaporizer to provide a combination of the solvent vapor and the gas; and
flowing the combination of the solvent vapor and the gas to the vessel.

18. The method according to claim 13, further comprising removing a first chemical other than the selected chemical from the liquid solution using a precipitant selective for the first chemical flowing through the vessel.

19. The method according to claim 18, further comprising removing a second chemical other than the selected chemical and the first chemical from the liquid solution using a sorbent selective for the second chemical flowing the vessel, wherein the selected chemical is removed using the solvent.
